(19) United States
(12) Patent Application Publication
(10) Pub. No.: US 2012/0108119 A1
(43) Pub. Date: May 3, 2012

(54) SURFBOARD STRAP SYSTEM

(75) Inventor: Bill G. Foster, Laguna Beach, CA (US)

(73) Assignee: Surf Products International, LLP, Laguna Beach, CA (US)

(21) Appl. No.: 13/220,094

(22) Filed: Aug. 29, 2011

Related U.S. Application Data
(60) Provisional application No. 61/456,042, filed on Nov. 1, 2010.

(51) Int. Cl. B63B 35/79; B23P 11/00; B63B 35/85

(52) U.S. Cl. 441/74; 29/428

(57) ABSTRACT

A surfboard foot strap system and methods of use and manufacture are disclosed by which a surfer's foot can be maintained adjacent to a top surface of the surfboard during a surfing maneuver. The strap system can include one or more straps that can be attached to a top surface of the surfboard. Further, in some embodiments, the strap system can comprise an array of mounting components disposed within the surfboard to which the straps can be removably attached. The strap system can enable a surfer to confidently place their foot into the strap without adjusting the strap or searching for a specific foot position. Further, the strap system allows the surfer to move their feet during a surfing activity while maintaining their feet in proximity and/or contact with the surfboard.

### CROSS-REFERENCE TO RELATED APPLICATIONS

This application claims the benefit of U.S. Provisional Application No. 61/456,042, filed Nov. 1, 2010, the entirety of which is incorporated herein by reference.

### BACKGROUND

1. Field of the Inventions

The present inventions relate to surfing accessories, and more specifically, a uniquely configured to surfboard strap system that can enable a surfer to maintain a connection with the surfboard during use.

2. Description of the Related Art

Various mechanisms have been developed over the years to enable a person to strap their feet onto a board during snow or water sports. For example, in snowboarding, a snowboarder must strap their boots into bindings that are fastened to a snowboard. Once strapped in, the snowboarder becomes firmly interconnected with the snowboard in a manner that prevents the snowboarder's boots from shifting or becoming disengaged from the bindings of the snowboard. Generally, the snowboarder cannot disengage from the bindings unless the bindings are loosened by the snowboarder either intentionally or perhaps during a fall. Further, snowboard bindings are intended to be durable, rigid structures that are attached to a relatively thin snowboard.

Certain water sports also use a board that has bindings or mechanisms intended to be engaged by a rider's foot. For example, kite surfing, wake boarding, and windsurfing are water sports in which the rider places their foot into bindings fastened to the top of the board. The rider is able to stand in the bindings in order to connect with the board. Similar to the snowboard bindings, bindings on kite surfing, wake boarding, and windsurfing boards are rigid structures that are intended to securely engage the feet of the rider. These bindings are intended to provide a stable structure that restricts lateral movement of the feet so that the rider can comfortably manipulate the board over waves at high speed while being towed or pulled by the wind or a boat.

### SUMMARY

In accordance with at least some of the embodiments disclosed herein is the realization that none of the prior art foot binding mechanisms can be comfortably and effectively used with a standard surfboard. As noted above, traditional foot bindings are generally rigid structures that are attached to an upper surface of a board, which makes them incompatible and uncomfortable for use in a traditional surfing activity that requires a surfer to lay down on the board while paddling. Further, traditional foot bindings permit little if any lateral or rearward/forward movement of the foot when the rider is engaged in the activity, which undermines the fundamental balance and feel that are so critical to developing superior surfing skills.

Accordingly, some embodiments of the present inventions provide a surfboard foot strap assembly that enables a rider or surfer to perform aerial maneuvers that have never been possible in traditional short board surfing. As used herein, the term “traditional surfing” applies to a surfing activity in which the surfer “drops in” to a wave by paddling into position to catch a wave and the “pops-up” or stands up on the board, after which the rider can ride the wave and perform various maneuvers. Embodiments disclosed herein are superior to and provide a functionality that was not known with prior art devices. Accordingly, embodiments disclosed herein represent a revolutionary advance for traditional surfing.

In accordance with at least some of the embodiments disclosed herein is the realization that although various devices have been created to create a mounting or binding between a rider's foot and a substrate or board that the rider is riding, no such device has been available for traditional surfing that allows a surfer to quickly engage or disengage their feet with the board or a binding. Instead, typical devices require a rider to strap their feet into a binding or otherwise conform a foot retaining device to their feet by adjusting the size and fit of the device to conform to their feet.

Therefore, in accordance with at least some embodiments disclosed herein is the realization that no prior device could be or would be used during a traditional surfing activity because they use heavy, bulky, obtrusive, and/or rigid materials, they do not permit quick entrance or egress of the feet from the bindings, and they do not allow a rider to shift their weight or adjust their foot position.

Some prior art foot binding devices may be useful in some surf-related activities, such as wake boarding and tow-in surfing, where the rider does not lay down and then quickly “pop-up” or stand up on the board to catch a wave. However, traditional surfing would not be possible using devices that make it difficult for the surfer to easily lay down on their board to paddle. Further, the “holy grail” of traditional surfing is to develop a keen awareness and ability to sense and feel the wave, which is only possible when the surfer has direct contact between their feet and the board. As such, foot bindings that a surfer stands on while surfing create unwanted “noise” and act as an impediment to the surfer's ability to feel the wave, which thus undermines the primary goal of traditional surfing.

Further, some prior art foot bindings can tend to interfere with leash movement, which can result in snapping the leash or damaging the foot binding, both of which are unacceptable outcomes. In accordance with embodiments disclosed herein, the strap system does not interfere with or become entangled with the surfer's leash, thereby minimizing any possibility of damage or harm to the board or to the surfer.

Finally, another relevant consideration to traditional surfing is minimizing the weight of the board so as to maximize the buoyancy and agility of the board. Traditional surfing would not use heavy or bulky devices such as those disclosed in the prior art because they would weigh down the surfboard and reduce the board's capabilities for the surfer. Indeed, just as in professional cycling, every ounce matters in surfing, and the lighter, the better a surfer can perform by more easily catching waves or executing skillful maneuvers. Various embodiments disclosed herein provide for a uniquely simple assembly by which the additional weight of the assembly is minimal, thereby making a minimal impact on the overall weight of the surfboard and maximizing the capabilities of the surfer.

According to some embodiments, a surfboard foot strap assembly is provided for use with a surfboard for maintaining a surfer's feet adjacent to a top surface of the surfboard during a surfing maneuver. The assembly can comprise one or more straps, one or more mounting pads, and an attachment means, such as an adhesive, by which the mounting pads in the straps can be attached to a surfboard.

For example, the assembly can comprise a pair of first mounting pads and a first elongate strap. The pair of first mounting pads can have an engagement complement and a lower surface being attachable to the top surface of the surfboard. The first elongate strap can have opposing ends that are coupled to the respective ones of the pair of first mounting pads. The first elongate strap can be attachable to the top surface of the surfboard to define a first opening having a first width. The first elongate strap can be configured to extend transversely relative to a longitudinal axis of the surfboard. The first elongate strap can also be configured to be attachable to the top surface of the surfboard adjacent to opposing side edges of the surfboard such that the first width of the first opening is at least about 12 inches.

The assembly can also comprise a pair of second mounting pads and a second elongate strap having opposing ends that are coupled to the respective ones of the pair of second mounting pads. The second elongate strap can be attachable to the top surface of the surfboard to define a second opening having a second width. The second width can be at least about 12 inches.

In accordance with some embodiments, the first width can be between at least about 12 inches and/or less than or equal to about 26 inches. Further, the first width can be between at least about 15 inches and/or less than or equal to about 25 inches. The first width can also be between at least about 19 inches and/or less than or equal to about 24 inches. In some embodiments, the first width can be about 23 inches. Further, the second width can be between at least about 12 inches and/or less than or equal to about 22 inches. The second width can also be between at least about 14 inches and/or less than or equal to about 20 inches. Furthermore, the second width can be between at least about 15 inches and/or less than or equal to about 18 inches. In some embodiments, the second width can be about 16 inches. Moreover, although the first and second widths can be modified in any variety of combinations, some embodiments can be provided in which the first width is between about 16 inches and about 24 inches and the second width is between about 14 inches and about 18 inches.

The assembly can be configured such that the first and second straps are biased toward a deployed position in which central portions of the first and second straps are spaced from the top surface of the surfboard. Further, the first and second straps can be deformable toward a stowed position in which the central portions of the first and second straps are positioned adjacent to the top surface of the surfboard. In this regard, the first and second straps can be formed from a resilient material.

In addition, a surfboard foot strap kit can also be provided. The kit can be configured for application to a surfboard for maintaining a surfer's feet adjacent to a top surface of the surfboard during a surfing activity. The kit can comprise a first elongate strap, a second elongate strap, a first pair of attachment components, and a second pair of attachment components.

The first elongate strap can define opposing ends being attached to the top surface of the surfboard to define a first opening having a first width. The first elongate strap can be configured to extend transversely relative to a longitudinal axis of the surfboard. The second elongate strap can have opposing ends being attachable to the top surface of the surfboard to define a second opening having a second width. The second elongate strap can be configured to extend transversely relative to a longitudinal axis of the surfboard.

Further, the first pair of attachment components can be attachable to the opposing ends of the first elongate strap. Each of the first pair of attachment components can comprise an opening for receiving a respective one of the opposing ends of the first elongate strap and a lower portion configured to face a top surface of the surfboard when attached thereto. Additionally, the second pair of attachment components can be attachable to the opposing ends of the second elongate strap. Each of the second pair of attachment components can comprise an opening for receiving a respective one of the opposing ends of the second elongate strap and a lower portion configured to face a top surface of the surfboard when attached thereto. Further, in some embodiments, the first and second widths can be at least about 12 inches.

In some embodiments, a “strap-enabled” surfboard can be provided that comprises a mounting system by which straps can be removable he and adjustably attached to the surfboard for maintaining a surfer's feet adjacent to a top surface of the surfboard during a surfing maneuver. The surfboard can comprise a core and a plurality of mounting components. In some embodiments, the mounting components discussed herein can be integrated into a core of the surfboard and/or mounted to a surface of the surfboard. The core can define a nose, a tail, opposing side edges, and an upper surface of the surfboard. The plurality of mounting components can be disposed in the core of the surfboard. The plurality of mounting components can be arranged to form a mounting array that extends at least partially along two or more areas of the upper surface of the surfboard. The mounting components can be configured to interconnect with respective ends of at least one strap such that the strap can extend at least partially across the upper surface of the surfboard.

The plurality of mounting components can comprise at least a pair of forward mounting components and a pair of rear mounting components. Further, the pair of forward mounting components can be positioned adjacent to the opposing side edges of the surfboard. Additionally, at least one of the mounting components of the pair of rear mounting components can be positioned adjacent to a side edge of the surfboard.

Optionally, the plurality of mounting components can comprise a set of forward mounting components and a set of rear mounting components. The forward mounting components can be positioned adjacent to opposing side edges of the surfboard. Further, at least one of the mounting components of the set of rear mounting components can be positioned adjacent to a side edge of the surfboard. In some embodiments, the forward mounting components can be arranged in rows extending adjacent to the opposing side edges of the surfboard. Further, the rear mounting components can be arranged in rows extending adjacent to the opposing side edges of the surfboard. Additionally, the rear mounting components can also include a row extending transversely relative to a longitudinal axis of the surfboard and which is positioned generally intermediate the forward mounting components and the rows of rear mounting components.

The surfboard can also comprise at least a first elongate strap defining first and second ends. The first and second ends of the first elongate strap can be attachable to respective mounting components of the surfboard. In addition, the surfboard can also comprise a second elongate strap defining first and second ends. The first and second ends of the second elongate strap can be attachable to respective mounting components of the surfboard such that the second elongate strap is positioned generally between the first elongate strap and the tale of the surfboard. The surfboard can be glassed. For example, at least an upper surface of the core can be glassed.

Further, in some embodiments, a surfboard foot strap assembly is provided for maintaining a surfer's feet adjacent to a top surface of the surfboard during a surfing activity. The foot strap assembly can comprise first and second rows of attachment points extending generally in a longitudinal direction along the top surface of the surfboard, an elongate strap having opposing ends, and attachment components coupled to the opposing ends of the elongate strap. The attachment components can be configured to removably secure the elongate strap to the top surface of the surfboard.

In some embodiments, the first and second rows of attachment points can each comprise between 2 to 8 attachment points. Further, the first and second rows of attachment points can extend generally adjacent to opposing sides of the surfboard. Respective attachment points of the first and second rows of attachment points can be spaced between at least about 12 inches and/or less than or equal to about 24 inches.

The assembly can also comprise a third row of attachment points extending in a direction transverse to a longitudinal axis of the surfboard along the top surface thereof and a fourth row of attachment points extending generally in a longitudinal direction along the top surface of the surfboard. In addition, the assembly can comprise a second elongate strap having opposing ends and second attachment components coupled to the opposing ends of the second elongate strap. The second attachment components can be configured to removably secure the second elongate strap to the top surface of the surfboard.

In some embodiments, respective attachment points of the first and second rows of attachment points can be spaced between at least about 12 inches and/or less than or equal to about 24 inches. Further, respective attachment points of the first and second rows of attachment points can be spaced between at least about 15 inches and/or less than or equal to about 21 inches. In addition, respective attachment points of the first and second rows of attachment points can be spaced between at least about 17 inches and/or less than or equal to about 19 inches.

In addition, some embodiments can comprise a system of mounting components in which one or more of the mounting components comprises one or more pairs of apertures for mounting a strap assembly thereto. The mounting components can engage with ends of the strap assembly with two or more fasting mechanisms extending therefrom. The two or more fasting mechanisms can tend to inhibit and/or prevent rotational movement of the strap assembly relative to the mounting component. For example, one end of a strap assembly can comprise a pair of fasting mechanisms extending therefrom to engage with the mounting component and/or the surfboard.

Furthermore, the mounting components can each comprise a body having a shape configured to prevent rotational movement of the mounting component relative to a core of the surfboard when the mounting component is implanted within the surfboard. For example, the body of the mounting component can comprise an elongate shape, one or more corners or protrusions, and/or other such features for engaging with the core of the surfboard and/or an adhesive or epoxy used to couple the mounting component with the core.

In some embodiments, the mounting components can define apertures for engaging with a strap assembly. The apertures can be aligned along respective longitudinal axes. Further, the longitudinal axes of the apertures of mounting components can be angularly oriented to be parallel and/or intersect at a given angle. The angular orientation of the longitudinal axes can be configured to allow a strap assembly to be angularly adjustable based on the position of the strap along the surfboard. For example, in a strap system having a plurality of mounting components, the mounting components of the system can be aligned at a variety of angular orientations as desired. Further, the mounting components can comprise individual or separate components and/or one or more combined mounting components. A combined mounting component can comprise an elongate member that comprises a plurality of apertures along the length thereof and which can be implanted along an edge or length of the surfboard.

Moreover, some embodiments can comprise an engagement or mounting component having a slot extending from an exterior surface towards an interior thereof. The slot can be in communication with one or more apertures configured to receive a fastening mechanism. The one or more apertures can be threaded. Further, a strap can be inserted into the slot and a fastening mechanism can be inserted and tightened into the aperture such that the fastening mechanism engages with the strap to retain the strap within the slot. In some embodiments, the slot can comprise one or more protrusions or teeth for assisting in strap retention. Further, a plurality of engagement components and/or a combined engagement components can be mounted or coupled to a core of the surfboard, as discussed herein with respect to other mounting components.

Methods of implementing and/or forming surfboard strap assemblies are also disclosed herein. For example, a method is provided for forming a surfboard foot strap system comprising installing a plurality of mounting components into a core of a surfboard. The plurality of mounting components can comprise one or more mounting components positioned adjacent to opposing side edges of the core along a top surface of the surfboard.

The method can comprise glassing the surfboard. The method can also comprise arranging the plurality of mounting components in two or more rows. For example, the arranging step can comprise arranging at least one row of the mounting components to extend along the length of the surfboard. Further, the arranging step can comprise arranging at least one row of the mounting components to extend adjacent to a side edge of the surfboard. The arranging step can also comprise arranging at least one row of the mounting components to extend transversely relative to a longitudinal axis of the surfboard. Moreover, the arranging step can comprise arranging a pair of forward rows of mounting components along a medial portion of the surfboard adjacent to opposing side edges thereof, arranging a pair of rear rows of mounting components along a tail portion of the surfboard adjacent to opposing side edges thereof, and arranging a transverse row of mounting components to extend transversely relative to a longitudinal axis of the surfboard and generally between the forward rows and the rear rows.

Further, a method of installing a surfboard foot strap system is also disclosed herein. The method can comprise positioning a first elongate strap on an upper surface of a surfboard and attaching the first elongate strap thereto. The first elongate strap can be positioned such that opposing ends thereof are spaced at a first width and the first elongate strap extends transversely relative to a longitudinal axis of the surfboard. The opposing ends thereof can be positioned adjacent to opposing side edges of the surfboard. Further, the first elongate strap can be attached to the upper surface of the surfboard to define a first opening with the opposing ends thereof being spaced that the first width. The first width of the first opening can be at least about 12 inches.

The method can also comprise positioning the opposing ends of the first elongate strap within a distance of between about ½ inch and/or less than or equal to about 5 inches from a side edge of the surfboard. Further, the positioning step can comprise positioning the opposing ends of the first elongate strap within a distance of approximately 1 ½ inches from the side of the surfboard.

In some embodiments, the method can also comprise positioning a second elongate strap on the upper surface of the surfboard and attaching the second elongate strap thereto. For example, the second elongate strap can be positioned such that opposing ends thereof are spaced at a second width. The opposing ends thereof can be positioned adjacent to opposing side edges of the surfboard. Further, the second elongate strap can be attached to the upper surface of the surfboard to define a second opening with the opposing ends thereof being spaced that the second width. The second width of the second opening can be at least about 12 inches. In addition, the attaching step can comprise a using an adhesive to attach the first elongate strap to the upper surface of the surfboard.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 is a perspective view of a surfboard foot strap assembly attached to a top surface of a surfboard, in accordance with an embodiment.

FIG. 2 is a top view of the surfboard foot strap assembly and the surfboard shown in FIG. 1.

FIG. 3A is a cross-sectional view taken along section lines 3A-3A of FIG. 1.

FIG. 3B is a side view of a strap of the surfboard foot strap assembly shown in FIG. 3A, according to an embodiment.

FIG. 4A is a cross-sectional view taken along section lines 4A-4A of FIG. 1.

FIG. 4B is a side view of a strap of the surfboard foot strap assembly shown in FIG. 4A, according to an embodiment.

FIG. 5 is a top perspective view of an attachment assembly of the surfboard foot strap assembly of FIG. 1, according to an embodiment.

FIG. 6A is a side cross-sectional view of an attachment assembly of a surfboard foot strap assembly, according to an embodiment.

FIG. 6B is a side cross-sectional view of an attachment assembly of a surfboard foot strap assembly, according to another embodiment.

FIG. 6C is a side cross-sectional view of an attachment assembly of a surfboard foot strap assembly, according to another embodiment.

FIG. 6D is a side cross-sectional view of an attachment assembly of a surfboard foot strap assembly, according to yet another embodiment.

FIG. 7 is a perspective view of an attachment component assembly of a surfboard foot straps assembly, in accordance with an embodiment.

FIG. 8 is a top view of a surfboard foot strap assembly attached to a top surface of a strap-enabled surfboard, in accordance with an embodiment.

FIG. 9A is a perspective view of an attachment assembly for the surfboard foot strap assembly shown in FIG. 8, according to an embodiment.

FIG. 9B is a side cross-sectional view of an attachment assembly for the surfboard foot strap assembly shown in FIG. 8, according to an embodiment.

FIG. 9C is a side cross-sectional view of an attachment assembly for the surfboard foot strap assembly shown in FIG. 8, according to an embodiment.

FIG. 10A is a perspective view of an attachment assembly for a surfboard foot strap assembly, according to an embodiment.

FIG. 10B is a side cross-sectional view of an attachment assembly for a surfboard foot strap assembly, according to an embodiment.

FIG. 10C is a side cross-sectional view of an attachment assembly for a surfboard foot strap assembly, according to an embodiment.

FIG. 11A is a side cross-sectional view of an attachment assembly for a surfboard foot strap assembly, according to an embodiment.

FIG. 11B is a side cross-sectional view of an attachment assembly for a surfboard foot strap assembly, according to an embodiment.

FIGS. 12A-C are perspective views of embodiments of mounting components.

FIG. 13 is a top view of a strap-enabled surfboard according to an embodiment.

FIG. 14 is a top view of a strap-enabled surfboard according to another embodiment.

FIG. 15A is a perspective view of a portion of an attachment component assembly, according to yet another embodiment.

FIG. 15B is a side cross-sectional view of the portion of the attachment component assembly of FIG. 10A wherein another portion of the assembly is coupled thereto, according to an embodiment.

FIG. 16A is a perspective view of an engagement component, according to an embodiment.

FIG. 16B is a cross-sectional side view of the engagement component of FIG. 16A wherein a strap is engaged therewith, according to an embodiment.

FIG. 17 is a top view of a strap-enabled surfboard according to yet another embodiment.

### DETAILED DESCRIPTION

While the present description sets forth specific details of various embodiments, it will be appreciated that the description is illustrative only and should not be construed in any way as limiting. Additionally, it is contemplated that although particular embodiments of the present inventions may be disclosed or shown in the context of surfing, such embodiments can be used in other sports that require a board, and in particular, sports that require the foot or feet of the participant to be secured relative to the board. Furthermore, various applications of such embodiments and modifications thereto, which may occur to those who are skilled in the art, are also encompassed by the general concepts described herein.

In accordance with an embodiment, a consumer surfboard binding or strap system can be provided that comprises one or more straps and one or more pads or brackets. A pad can be attached to each end of a strap and set or mounted on a surfboard by a consumer or retailer in an aftermarket or retrofitting process using an adhesive. The adhesive can comprise one or more of a variety of joining materials, such as synthetic and/or natural resins and gums, including epoxy, glue, cement, and the like.

In some embodiments, the strap can comprise a single piece of material. The strap can be flexible. The strap can be a generally inelastic yet resilient material.

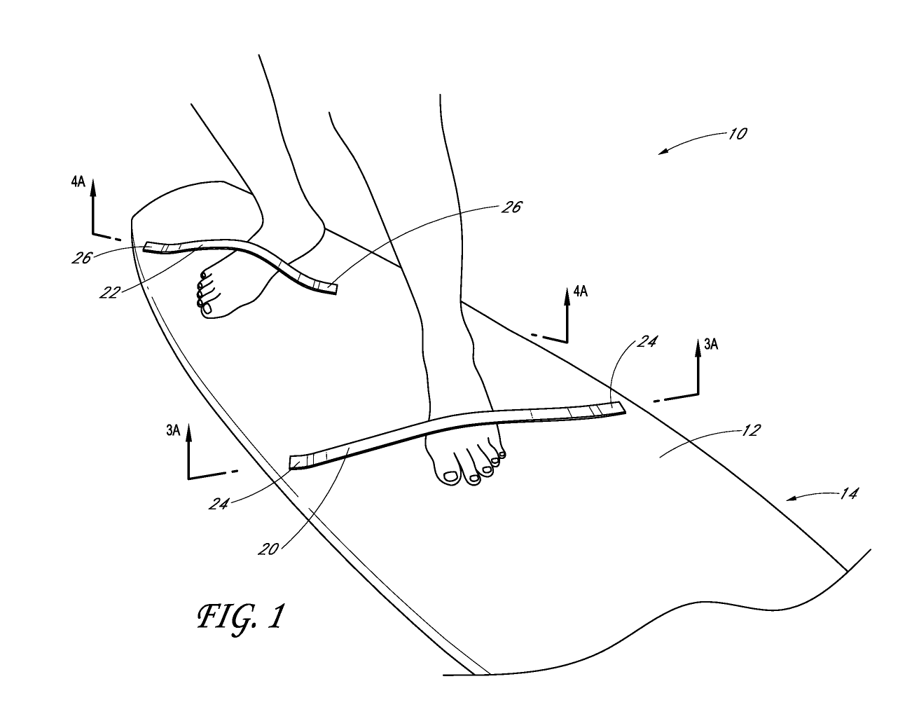

For example, FIG. 1 illustrates a perspective view of a surfboard binding system or foot strap assembly 10 attached to a top surface 12 of a surfboard 14. Some embodiments of the foot strap assembly 10 can be configured to attach superficially to the top surface 12 of the surfboard 14. However, some embodiments of the foot strap assembly 10 can also be configured to engage with the surfboard 14 by extending through the top surface 12, for example, to engage with a component positioned or mounted in a core of the surfboard 14.

The embodiments illustrated in FIGS. 1-7 can enable a user to superficially mount straps of the assembly 10 onto the top surface 12 of the surfboard 14 in a pattern or arrangement desired by the surfer. As discussed further below, in some embodiments, although this superficial mounting may be temporary, it can be done using semi-permanent or permanent adhesives such that the position of the straps can be fixed once they are mounted onto the surfboard.

As illustrated, the foot strap assembly 10 can comprise a pair of foot straps, shown as a first or forward strap 20 and a second or rear strap 22. The first strap 20 can be coupled to the surfboard 14 using a pair of pads or brackets 24. Further, the second strap 22 can be coupled to the surfboard 14 using a pair of pads or brackets 26. The orientation and placement of the first and second straps 20, 22 can be dictated by the preferences of the rider or surfer.

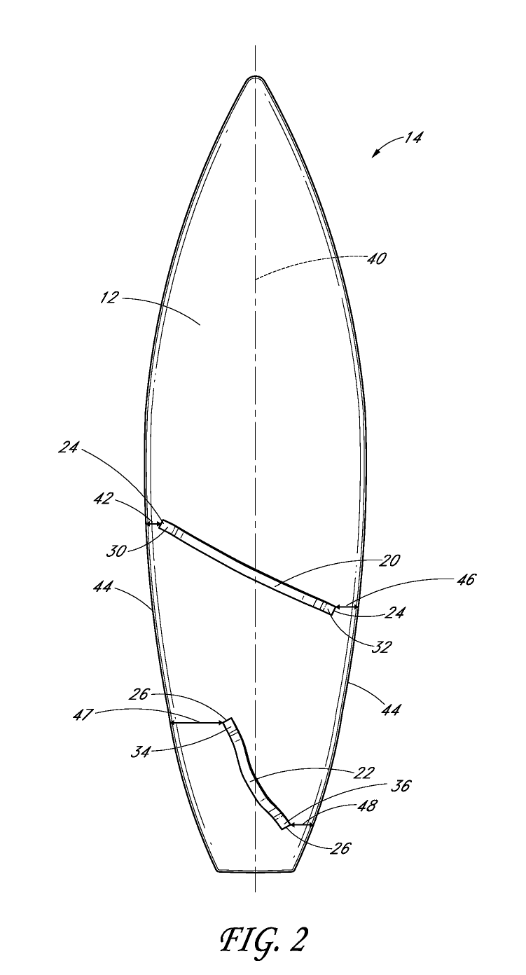

For example, some surfers may ride regular-footed with the left foot forward while others may ride “goofy-footed” with the right foot forward. The arrangement illustrated in FIG. 1 is an example of a surfer riding regular footed. Thus, as shown in FIG. 2, the first or forward strap 20 is angled such that a left end 30 is the forward-most end of the first strap 20 while a right end 32 is a rearward-most end of the strap 20. This arrangement is repeated with the left and right ends 34, 36 of the second or rear strap 22. For a goofy-footed surfer, the first and second straps 20, 22 can be rearranged in a minor image along longitudinal axis 40 of the surfboard 14. Thus, as shown in FIGS. 1-2, the system or assembly can be installed on a surfboard by positioning the pads 24, 26 of the first and second straps 20, 22 in a desired orientation and adhering the pads 24, 26 to the top surface 12 of the surfboard 14.

Further, as illustrated in FIG. 2, the left end 30 of the forward strap 20 can be spaced at a distance 42 from a side edge 44 of the surfboard 14. Further, the right end 32 of the first strap 20 can be spaced at a distance 46 from the side edge 44 of the surfboard 14. Additionally, the left and right ends 34, 36 of the second or rear strap 22 can be spaced at respective distances 47, 48 from the side edge 44 of the surfboard 14. These distances 42, 46, 47, 48 can be configured such that the respective ends are within between about ½ inch and/or less than or equal to about 5 inches from a side edge 44 of the surfboard. These distances 42, 46, 47, 48 can also be configured such that the respective ends are within between about 1 inch and/or less than or equal to about 2 inches from a side edge 44 of the surfboard. Further, the distances 42, 46, 48 can be configured such that the respective ends are within approximately 1½ inches from the side edge 44 of the surfboard. In addition, in some embodiments, the distance 47 can be configured such that the left end of the rear strap 22 can be within between about 4 inches and/or less than or equal to about 8 inches from a side edge of the surfboard. Further, because the embodiment illustrated in FIG. 2 provides an example of a natural or regular-footed arrangement of the straps 20, 22, the spacing and arrangement can be reversed or otherwise modified to accommodate a situation in which the straps are arranged for a goofy-footed surfer.

As illustrated in FIG. 2, some embodiments disclosed herein provide for a strap system in which one or both of the straps extends along a majority of the width of the surfboard 14. Indeed, some embodiments of the straps can extend along a vast majority of the width of the surfboard, between 70-95 percent of the width while providing an opening into which the surfer can slip their foot. Further, such embodiments can also be oriented at a diagonal relative to a longitudinal axis of the surfboard.

Thus, in contrast to other prior art foot bindings for board-based activities, some embodiments of the strap system disclosed herein provide a wide-open space or opening. For example, the opening can be configured such that it does not contract or conform to the surfer's foot. Instead, the surfer's foot can move freely into, out of, and/or along the space or opening created by the strap in order to allow the surfer to shift their weight, adjust their stance, and quickly place or remove their foot from the space or opening of the strap. This ability is not made possible using any of the prior art foot bindings. This ability is also critical when the surfer has to pop-up on the surfboard, gain their balance, and adjust their stance on the board. This ability is also critical after the surfer drops into the wave and completes a “bottom turn” and comes up along the face of the wave, during which time the feet may be shuffled in order to rebalance or shift weight along the surfboard. Thus, the feet are not fixed, locked into, or required to be in a given position as in prior art foot bindings.

Further, when the surfer attempts to perform a maneuver, such as in aerial, including flips and other airborne acrobatics, the strap can come into contact with the foot to maintain the foot within a desired distance and/or in contact with the top surface of the surfboard. However, as discussed herein, this maintenance of proximity between the foot and the top of the surfboard can be achieved without limiting or impeding the foot from lateral and/or rearward/forward movement or rotation along any axis (pitch, yaw, roll). Indeed, embodiments of the strap systems disclosed herein allow a surfer to move their feet anywhere across the surfboard, whether laterally or in a rare word-forward movement. Thus, in some maneuvers which often require a surfer to move their feet between 2-10 inches, the strap systems disclosed herein provide a unique ability that prior art foot bindings do not. Accordingly, in contrast to prior art foot bindings, the surfer can easily step in to the openings created by the straps of the strap system to maintain contact with the board while not being constrained from moving their feet laterally, rearwardly, forwardly, and/or rotating their feet in pitch, yaw, and/or roll rotational directions. Embodiments disclosed herein can provide such superior capabilities which have hitherto been unavailable in the art.

For example, in accordance with some embodiments disclosed herein is the realization that prior art foot bindings assume that the surfer is already in the straps (as if the surfer were really wake boarding or tow-in surfing). However, in the real world, a surfer will not have time to strap into a foot binding assembly or search for a place to put their foot. Further, in the real world, a surfer will not always keep their feet in the same location on the surfboard—indeed, the infinite variables of position and balance require the ability for constant adjustment and repositioning. A skilled surfer understands how to roll or shift their weight along the board from the inside to the outside of the foot and vice versa. A surfer's control and balance require adjustability through movement in three dimensions (x, y, and z) and rotation about those three dimensional axes to provide roll, pitch, and yaw. Accordingly, embodiments disclosed herein enable a surfer to slide, shift, reposition, and/or transfer weight with their feet in a manner that is not possible using prior art devices.

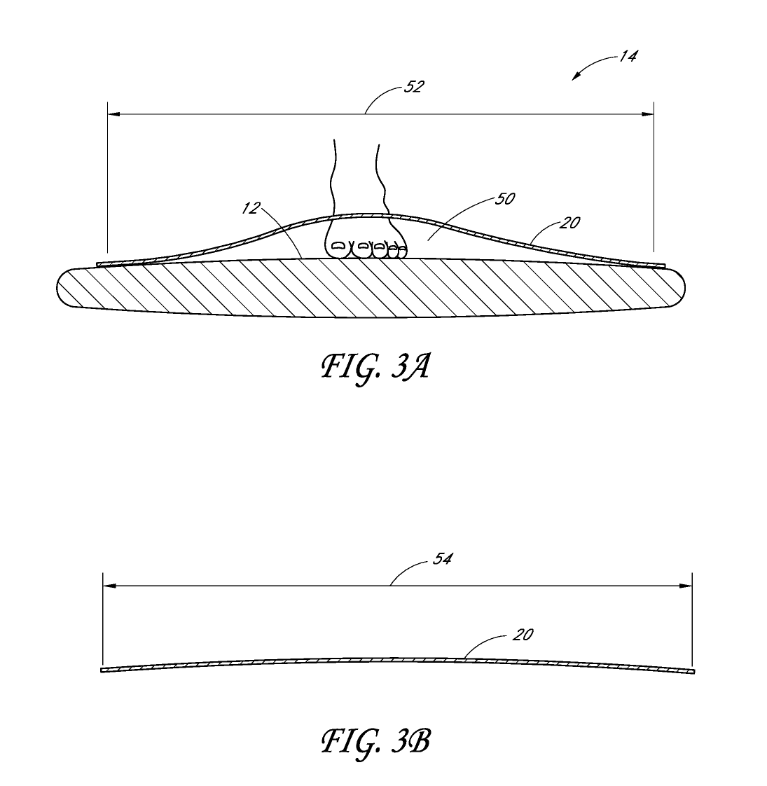

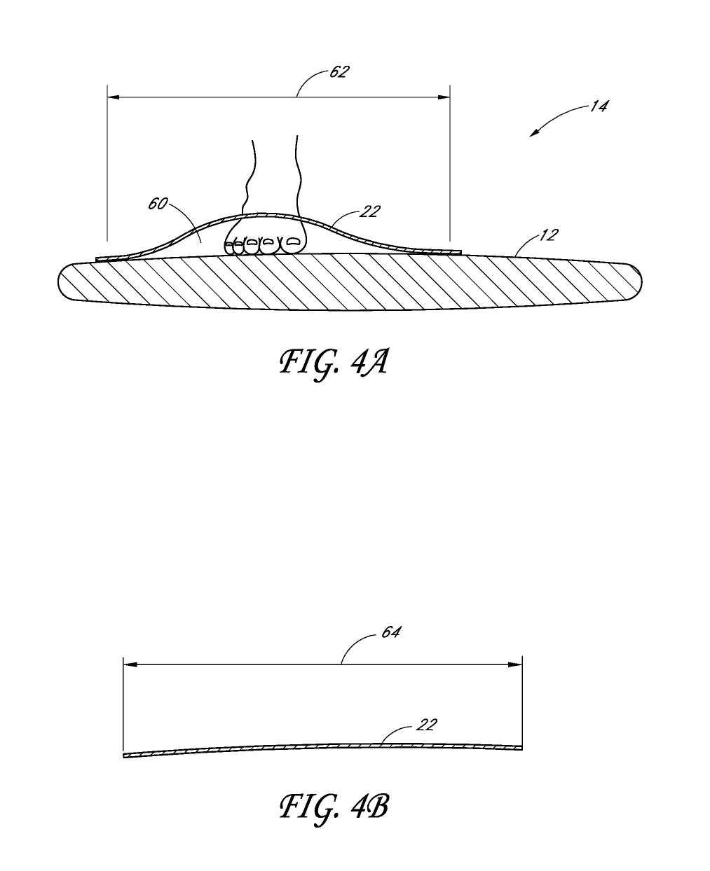

Referring to the illustrations of FIGS. 3A-4B, these figures demonstrate an operational configuration of an embodiment of a foot strap assembly. As shown in FIG. 3A, a surfer's foot can be positioned within an opening 50 formed between the first strap 20 and the top surface 12 of the surfboard 14. The opening 50 can define a first width 52 that can be measured from one end of the strap to the other along the top surface 12 surfboard 14. The length of the first strap 20 can be configured such that the foot can be easily inserted into the opening 50 with the first strap 20 being comfortably positioned over the instep of the foot the first width 52 of the opening 50 being sufficiently wide to allow the foot easily find and exit the opening 50. The first width 52 can be between at least about 12 inches and/or less than or equal to about 26 inches. Further, the first width 52 can be between at least about 15 inches and/or less than or equal to about 25 inches. The first width 52 can also be between at least about 19 inches and/or less than or equal to about 24 inches. In some embodiments, the first width 52 can be approximately 23 inches.

In addition, as discussed herein, the first strap 20 and the second strap 22 can comprise any resilient, the flexible material that can easily be deflected towards the top surface of the surfboard when the surfer is laying down and paddling. However, the first strap 20 and the second strap 22 can immediately spring up when the surfer pops-up while catching a wave. In some embodiments, the first and second straps 20, 22 can be shaped generally as a bell curve when in a deployed or extended position.

Once attached, the first and second straps 20, 22 will provide an opening that can be large enough to accommodate the infinite number of stances or foot positions that a surfer (or many surfers using the same board) may have when standing up on the board and surfing. In some embodiments, the first strap 20 and the second strap 22 can each define an opening that has a generally constant perimeter. Thus, the strap system can accommodate an incredible range of foot positions without requiring any adjustment before or during the surfing activity.

Further, FIG. 3B illustrates that the first strap 20 can define a first length 54. In order for the first strap 20 to comfortably fit over an instep of approximately 2-4 inches in height, and an average of approximately 3 inches, the first length 54 of the first strap 20 can be between at least about 14 inches and/or less than or equal to about 28 inches. The first length 54 of the first strap 20 can also be between at least about 18 inches and/or less than or equal to about 26 inches. The first length 54 of the first strap 20 can also be between at least about 21 inches and/or less than or equal to about 24 inches.

For example, the first strap 20 can define a first length 54 that is approximately 24 inches, and when attached to the surfboard, the ends of the first strap 20 can be spaced such that the first width 52 of the opening 50 is approximately 23 inches, which would enable a foot to be placed into the opening 50 such that the first strap 20 can be spaced at approximately 3 inches from the top surface 12 of the surfboard 14. Such an embodiment would provide a large enough opening 50 that would allow a surfer to immediately insert their foot into the opening 50 as they pop-up on the board. Further, such an embodiment would also allow the surfer to easily lay down on the first strap 20 and have the first strap 20 be nearly undetectable. Thus, the illustrated embodiment can provide excellent advantages that are not possible using prior art foot bindings.

Similar to FIGS. 3A-B, FIGS. 4A-B illustrate the second strap 22 that can be attached to the top surface 12 of the surfboard 14 closer to the tale of the surfboard 14 than the first strap 20. As illustrated, the second strap 22 can be attached to the surfboard 14 to define an opening 60 into which the surfer's foot can be placed. The opening 60 can define a second width 62 that can be measured from one end of the second strap 22 to the other along the top surface 12 surfboard 14. The length of the second strap 22 can be configured such that the foot can be easily inserted into the opening 60 with the second strap 22 being comfortably positioned over the instep of the foot the second width 62 of the opening 60 being sufficiently wide to allow the foot easily find and exit the opening 60. The second width 62 can be between at least about 10 inches and/or less than or equal to about 24 inches. Further, the second width 62 can be between at least about 12 inches and/or less than or equal to about 20 inches. The second width 62 can also be between at least about 14 inches and/or less than or equal to about 18 inches. In some embodiments, the second width 62 can be approximately 16 inches.

Further, FIG. 4B illustrates that the second strap 22 can define a second length 64. In order for the second strap 22 to comfortably fit over an instep of approximately 2-4 inches in height, and an average of approximately 3 inches, the second length 64 of the second strap 22 can be between at least about 12 inches and/or less than or equal to about 24 inches. The second length 64 of the second strap 22 can also be between at least about 13 inches and/or less than or equal to about 21 inches. The second length 64 of the second strap 22 can also be between at least about 16 inches and/or less than or equal to about 18 inches.

For example, the second strap 22 can define a second length 64 that is approximately 17 inches, and when attached to the surfboard, the ends of the second strap 22 can be spaced such that the second width 62 of the opening 60 is approximately 16 inches, which would enable a foot to be placed into the opening 60 such that the second strap 22 can be spaced at approximately 3 inches from the top surface 12 of the surfboard 14. Such an embodiment would provide a large enough opening 60 that would allow a surfer to immediately insert their foot into the opening 60 as they pop-up on the board. Further, such an embodiment would also allow the surfer to easily lay down on the second strap 22 and have the f second strap 22 be nearly undetectable. Thus, as with the first strap 20, the illustrated embodiment of the second strap 22 can provide excellent advantages that are not possible using prior art foot bindings.

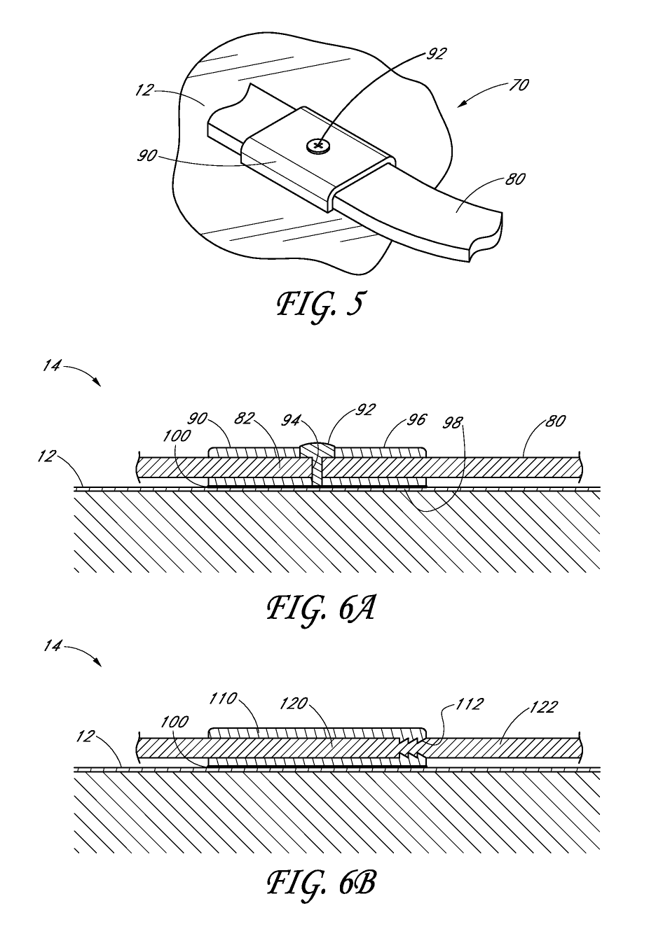

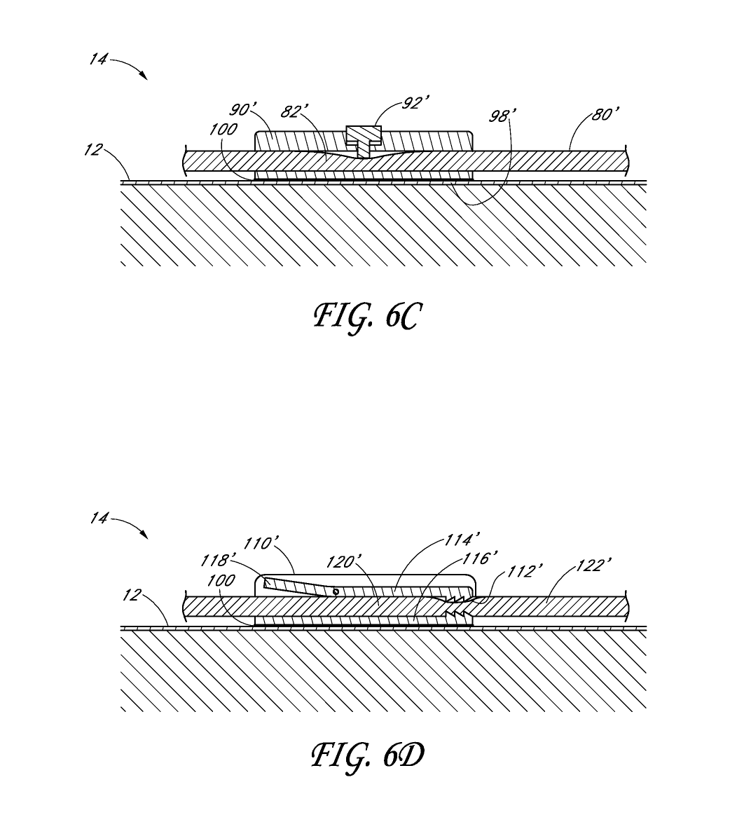

As noted above, in some embodiments, the straps of the strap assembly can be attached superficially to the top surface of the surfboard. For example, as shown in FIGS. 5-6A, a strap 70 can comprise a strap portion 80 and an attachment component 90. The attachment component 90 can be attached to an end 82 of the strap portion 80. Further, the attachment component 90 can be attached to the top surface 12 of the surfboard 14.

As illustrated in FIG. 6A, the attachment component 90 can also comprise a fastening component 92 that extends through and/or forms a hole 94 formed in the end 82 of the strap portion 80. The fastening component 92 can comprise a blunt or self-tapping screw, a pin, a rivet, or other such fastening devices for engaging with the end 82 of the strap portion 80 of the attachment component 90. The fastening component 92 can be threaded. In some embodiments, the fastening component 92 may extend all of the way through the attachment component 90 from a top surface 96 to a bottom surface 98 thereof. However, the bottom surface 98 of the attachment component 90 can be generally flat such that it can be mounted generally flush relative to the top surface 12 of the surfboard 14.

Further, as shown in FIG. 6A, the strap 80 can extend all the way through the attachment component 90. As such, the attachment component 90 can comprise a slot or passageway into which the strap 80 can be advanced. The fastening component 92 can be advanced or withdrawn from engagement with the strap 80 in order to allow the user to adjust the length of the strap 80 positioned between two attachment components of the system. Accordingly, the user can increase or decrease the length or size of the strap to increase or decrease the size of the opening formed by the strap. Further, the quick interchangeability provided by the embodiment shown in FIGS. 5-6A (as well as various other embodiments disclosed herein) can enable a user to remove and replace straps quickly and easily (for example, if the strap has been broken, damaged, or otherwise needed to be replaced for mechanical or cosmetic reasons). Thus, an interchangeable strap system can be beneficial in various embodiments to provide simple and complete manipulatability of the system in order to meet the aesthetic, functional, and fitting requirements of one or various users.

The assembly can also comprise an adhesive or engagement component 100. The adhesive or engagement component 100 can comprise a joining material, such as synthetic and/or natural resins and gums, including epoxy, glue, cement, and the like, and/or any variety of mechanical fastening features, such protrusions, recesses, slots, and the like to correspond with mechanical fastening features of the surfboard. Such materials and features can provide a strong bond between the attachment component 90 and the top surface 12 of the surfboard 14. The adhesion and/or engagement between the attachment component 90 and the top surface 12 can be permanent or temporary, and can be direct and/or indirect.

In accordance with another embodiment, FIG. 6B illustrates an attachment component 110 configured to cramp or clamp onto an end 120 of a strap portion 122. Thus, some embodiments of the attachment component can be configured to provide a frictional, adhesive, or interference-type engagement with the strap portion. As shown in the illustrated example, the attachment component 110 can comprise engaging teeth 112 to enhance the engagement with the strap portion 122. As illustrated, the teeth 112 can allow the strap portion 122 to pass in a first direction through a slot or aperture of the attachment component 110 while restricting movement of the strap portion 122 in a second direction. As such, in some embodiments, the strap portion 122 may be inserted into the attachment component 110 and retained by the attachment component 110 without the use of a fastening component.

Thus, according to some embodiments, the strap assembly can include a strap, a pair of attachment components that can be attached to either end of the strap, and an adhesive material to couple or join the attachment components to the top surface of the surfboard. Further, as noted above with respect to FIG. 6A, an adhesive component 100 can also be used to couple or join the attachment component 110 to a top surface 12 of the surfboard 14.

In accordance with yet another embodiment, FIG. 6C illustrates a modified version of the attachment component shown in FIG. 6A. As illustrated in FIG. 6C, the attachment component 90′ can comprise a fastening component 92′ that extends through the attachment component 90′ to contact the end 82′ of the strap portion 80′. The fastening component 92′ can be threaded. The fastening component 92′ can comprise a screw, a pin, a rivet, or other such fastening devices for frictionally engaging, compressing, and/or crimping at least a portion of the end 82′ of the strap portion 80′ of the attachment component 90′. In some embodiments, the fastening component 92′ can have a blunt or enlarged end for compressing the strap portion 80′. Further, the fastening component 92′ can be threadably coupled to the attachment component 90′ to allow a user to rotate the fastening component 92′ to loose end or tighten the fastening component 92′ against the strap portion 80′. As with other embodiments, such an embodiment can allow the user to interchange or adjust the strap and/or fit of the strap to customize the strap system. Further, as in other embodiments, the bottom surface 98′ of the attachment component 90′ can be generally flat such that it can be mounted generally flush relative to the top surface 12 of the surfboard 14.

Additionally, FIG. 6D illustrates another embodiment which is a modified version of the attachment component shown in FIG. 6C. In the embodiment of FIG. 6D, the attachment component 110′ can comprise a clamping portion 114′ that is pivotally coupled to a base portion 116′. The clamping portion 114′ and the base portion 116′ can be configured to engage an end 120′ of a strap portion 122′. For example, teeth 112′ of the clamping portion 114′ can be biased toward teeth 112′ of the base portion 116′. In some embodiments, the clamping portion 114′ can comprise a button or lever 118′ that can be pushed to move the clamping portion 114′ to a disengaged position. However, upon releasing the button or lever 118′, the clamping portion 114′ can spring back to an engaged position. The biasing mechanism can be formed, for example, by a spring.

Thus, some embodiments of the attachment component can be configured to provide a frictional, adhesive, toothed, or interference-type engagement with the strap portion. The engaging teeth 112′ can enhance the engagement with the strap portion 122′ and can comprise sharp edges, rounded edges, and/or other engagement features to engage with the strap portion 122′. As illustrated, the teeth 112′ can allow the strap portion 122′ to pass in a first direction through a slot or aperture of the attachment component 110′ while restricting movement of the strap portion 122′ in a second direction. As such, in some embodiments, the strap portion 122′ may be inserted into the attachment component 110′ and retained by the attachment component 110′ without the use of a fastening component.

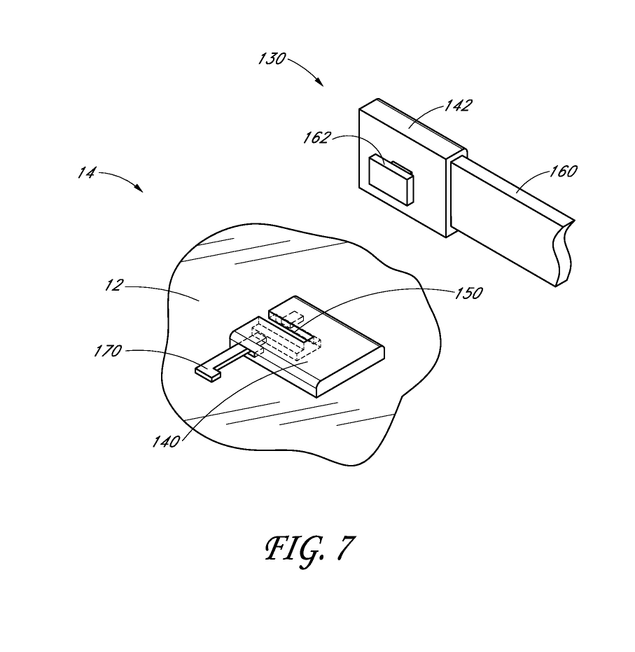

FIG. 7 illustrates another embodiment of an attachment component 130 that comprises a two-piece assembly enabling the strap to be removably coupled to the top surface 12 of the surfboard 14. As illustrated, the attachment component 130 can comprise a lower bracket 140 and an upper bracket 142. The lower bracket 140 can be mounted onto the top surface 12 of the surfboard 14 using an adhesive component as discussed above. The lower bracket 140 can comprise an engagement component 150, such as a slot, groove, protrusion, or recess, extending along at least a portion thereof. The upper bracket 142 can be mounted to an end of a strap 160 in a manner such as those discussed above. Further, the upper bracket 142 can comprise an engagement member 162, such as a protrusion, slot, groove, or recess, that can engage with the engagement component 150 of the lower bracket 140.

In some embodiments, the engagement member 162 of the upper bracket 142 can comprise a unique polygonal shape, such as a square, rectangle, triangle, hexagon, octagon, and the like. Such structure can be configured to provide a rotational fixation mechanism for this and other embodiments disclosed herein. For example, the engagement component 150 of the lower bracket 140 can be configured to complement the shape of the engagement member 162. Accordingly, in some embodiments, the lower and upper brackets 140, 142 can be engaged with each other in a fixed rotational position by virtue of the fit between the engagement component 150 and the engagement member 162.

Further, in the illustrated embodiment, a protruding element of the engagement member 162 can be received into a slot of the engagement component 150. In such an embodiment, the upper bracket 142 will be generally aligned with the lower bracket 140 in a single, fixed rotational position. However, in other embodiments, such as when the engagement member 162 is formed as a hexagon, the engagement number 162 can be rotated to one of a variety of fixed rotational positions at which the engagement member 162 and the engagement component 150 can be connected or engaged. The rotational fixation mechanism of such embodiments can enable the user to customize the orientation, fit and feel of the strap system. Thus, in such embodiments, the user can adjust not only the length of the strap, but can also adjust the orientation or angle of the strap to ensure optimal customization.

Further, in some embodiments, the lower bracket 140 can comprise a locking component 170 configured to prevent unintentional disengagement of the engagement member 162 from the engagement component 150. As shown, the locking component 170 comprise a pin or gate that blocks through the engagement component 150 by sliding or rotating into the slot or groove of the engagement component 150.

In accordance with another embodiment, an adjustable surfboard foot strap mounting system can be provided in which a surfboard comprises a plug or mounting system that enables straps to be removably or adjustably mounted to the surfboard in a variety of positions and locations. The system can comprise one or more straps, pads attached to the ends of the strap(s), and one or more pairs of plugs or mounting components attached to or built into the surfboard. In some embodiments, the mounting components discussed herein can be integrated into a core of the surfboard and/or mounted to a surface of the surfboard. An embodiment of the system can comprise one or more pairs of the pads or brackets illustrated and discussed above with respect to FIG. 7, in which case the straps can be adjustable between a plurality of positions and/or orientations on the surfboard. However, other embodiments will now be discussed in which the plug or mounting component comprises an internally-mounted structure that is installed onto or in the core of the surfboard before the surfboard is glassed.

Therefore, depending on the waves, the surfer's objective, or for allowing customization of a single board used by multiple surfers, the straps can be moved into a desired position and location and securely attached at any of a variety of predetermined positions and locations. Accordingly, the strap mounting system can provide excellent user customization and manipulation that can be done while sitting on the beach or even while sitting on the board waiting for a wave.

Further, some embodiments can allow a manufacturer to create a single model or a few models of a surfboard having a universal or desired arrangement of plugs or mounting locations as a built-in mounting system. As such, one or more models of a strap-enabled surfboard can be manufactured and sold, which can later be customized by the end-user (the surfer). Additionally, various interchangeable straps can be sold that can be used with the strap-enabled surfboards.

For example, a strap-enabled surfboard could have three unique models that each have different plug or mounting location arrangements based on the length, width, or size of the board. A few general sizes can be developed that correlate to the type of material used to make the board (such as polyurethane foam and polyester resin “PU/PE,” expanded polystyrene “EPS,” Wood, and other such materials now in use or that will be used in the future), the length of the board, the width of the board, the thickness of the board, the number of fins or fins slots, the type of tail of the board, the shape of the board, and/or other pertinent design or functional elements. Accordingly, various strap-enabled boards can be developed that incorporate a built-in mounting system.

Therefore, whereas some embodiments discussed above with respect to FIGS. 1-7 can be mounted in a semi-permanent or permanent fashion to define a generally fixed arrangement or position of the straps on the top surface of the surfboard, embodiments of adjustable systems can be provided to allow mobility and interchangeability of straps and positions or arrangements of the straps using a built-in mounting system.

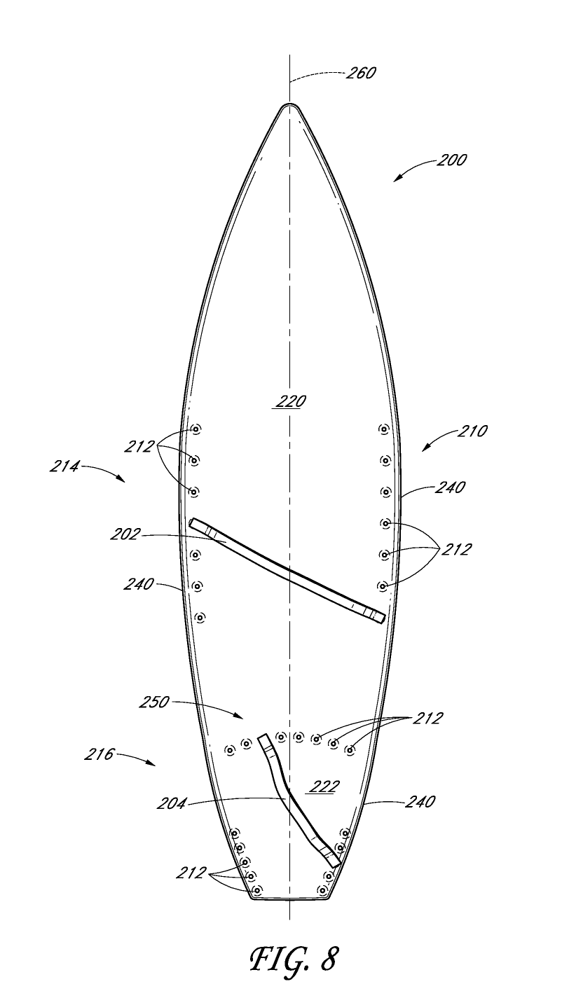

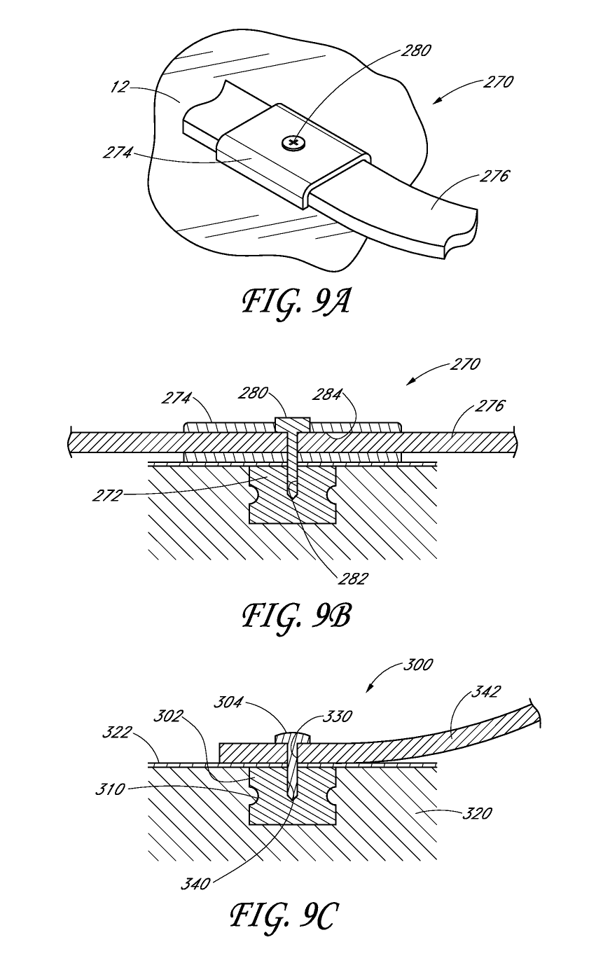

Referring now to FIG. 8, an embodiment of a strap-enabled surfboard 200 is shown. In the illustrated embodiment, a first or forward strap 202 and a second or rearward strap 204 can be mounted to a built-in mounting system 210 of the surfboard 200. As shown, the mounting system 210 can comprise an array or a plurality of plugs or mounting components 212. In some embodiments, the mounting or engagement components discussed herein and illustrated in FIGS. 8-17 can be integrated into a core of the surfboard and/or mounted to a surface of the surfboard. As discussed further herein, the mounting components 212 can each comprise single or dual apertures configured to engage with single or dual fastening components, such as those shown in FIGS. 9A-11B.

The mounting system 210 can comprise a first plurality 214 of plugs or mounting components 212 disposed along a medial portion 220 of the surfboard 200, which can be used to removably mount the first strap 202 in a plurality of locations and positions. Further, the mounting system 210 can also comprise a second plurality 216 of plugs or mounting components 212 disposed along a posterior portion 222 of the surfboard 200, which can be used to removably mount the second strap 204 in a plurality of locations and positions. As shown and discussed herein, the mounting components 212 can be arranged in one or more rows or clusters. The rows can be generally linear, arcuate, zig-zag, etc., as shown in the illustrated embodiments.

The first plurality 214 of mounting components 212 can be arranged along and/or adjacent to the lateral edges of the surfboard 200. For example, the mounting components 212 can each be between at least about 1 inch and/or less than or equal to about 6 inches from an edge 240 of the surfboard 200. In some embodiments, the mounting components 212 can be at least about 2 inches and/or less than or equal to about 5 inches from the edge 240 of the surfboard 200. Further, in some embodiments, the mounting components 212 can be approximately 2.5 inches from the edge 240 of the surfboard 200.

In addition, although the first plurality 214 of mounting components 212 is shown in a single pair of rows, three or more rows of mounting components 212 can be used in the array of mounting components 212. For example, dual rows of mounting components 212 can be positioned along either side of a midline or longitudinal axis 260 of the surfboard 200. Thus, the user can fine tune the spacing and position of the first strap 202 as desired.

The first plurality 214 of mounting components 212 can extend in two rows that run along the opposing lateral or side edges of the surfboard 200. In the illustrated embodiment, there are six mounting components 212 in each row. However, at least one and/or less than or equal to 14 mounting components can be used in each row. Further, the number of mounting components 212 in each row can be the same. However, the number of mounting components 212 in each row can also differ. For example, one row of the first plurality 214 of mounting components 212 can have two mounting components while the other row has five mounting components.

Furthermore, the mounting components 212 can be longitudinally spaced at a distance of at least about 1 inch and/or less than or equal to about 5 inches from each other. In some embodiments, the mounting components 212 can be longitudinally spaced at a distance of at least about 2 inch and/or less than or equal to about 4 inches from each other. In the illustrated embodiment, the mounting components 212 can be longitudinally spaced at a distance of about 3 inches from each other.

Moreover, the first plurality 214 of mounting components 212 can be arranged in one or more clusters of mounting components 212. Accordingly, the first plurality 214 need not be arranged in rows, but can be spaced apart in a random or fixed relationship in one or more areas of the medial portion 220 of the surfboard 200. For example, if the surfboard were to be targeted to only natural or regular-footed surfers, clusters of mounting components 212 could be arranged at offset longitudinal locations in the medial portion of the surfboard, with a left cluster being closer to the nose of the surfboard and the right cluster being closer to the tail of the surfboard.

Thus, the first plurality 214 mounting components 212 can be used to position the first strap 202 in a natural or regular-footed position (as shown) or in a goofy-footed position based on the user's preference.

The second plurality 216 of mounting components 212 can comprise a transverse row 250 of mounting components 212 and opposing rows of mounting components 212 that extend along or adjacent to the edge 240 of the surfboard 200. The transverse row 250 of mounting components 212 can extend and an arcuate pattern across a midline or longitudinal axis 260 of the surfboard 200. As shown, the transverse row 250 can be configured such that the pattern or array of mounting components 212 is a mirror image about the longitudinal axis 260. In the illustrated embodiment, the transverse row 250 comprises eight mounting components 212, with four on either side of the midline or longitudinal axis 260. As will be appreciated, the mounting components 212 on the left side of the midline or longitudinal axis 260 can be used to mount the second strap 204 in a natural or regular-footed position (as shown) or in a goofy-footed position based on the user's preference.

Further, although FIG. 8 illustrates the first and second straps 202, 204 in a given orientation, the straps 202, 204 can each or both be re-oriented to any variety of orientations.

In addition, as discussed above with respect to the first plurality 214 of mounting components 212, the transverse row 250 and the opposing rows of mounting components 212 of the second plurality 216 can comprise additional rows of mounting components in combination with those illustrated in FIG. 8. Thus, the transverse row 250 can comprise two or more rows of mounting components 212 extending transversely relative to the midline or longitudinal axis 260 of the surfboard 200. Further, the transverse row 250 could be rearranged into a cluster of mounting components 212, as discussed above. For example, the transverse row 250 could be rearranged into a single cluster on a right side of the longitudinal axis 260 if the board were targeted to only natural or regular-footed surfers.

Further, the opposing rows of the second plurality 216 of mounting components 212 can also be configured as three or more rows or clusters of mounting components, as discussed above with respect to the first plurality 214 and a transverse row 250 of mounting components 212.

In addition, the spacing of the second plurality 216 of mounting components 212 can be configured using similar guidelines such as those mentioned above with respect to the first plurality 214 of mounting components 212. Therefore, a discussion of the spacing of the mounting components 212 from the edge 240 and relative to each other will not be repeated, but applies equally to the second plurality 216 of mounting components. Further, as illustrated in FIG. 8, the spacing of the second plurality of mounting components can be even tighter than the first plurality 214 of mounting components 212. For example, the mounting components 212 of the second plurality 216 can also be spaced between about ½ inch and/or less than or equal to about 1½ inches from each other. In some embodiments, the mounting components 212 of the second plurality 216 can be spaced approximately 1 inch from each other.

In order to place, install, and/or attach a mounting component to the surfboard, the core of the surfboard can be prepared by creating a recess, the mounting component can be forced or drilled into the core, and/or the mounting component can be formed along with the core, for example, in a mold. Further, an adhesive, such as in epoxy or other such adhesives can be used to further secure the mounting component to the core. Thereafter, the core can be glassed as known in the art.

FIGS. 9A-11B illustrate cross-sectional views of embodiments of strap mounting assemblies that can be used to attach one or more straps of an adjustable strap system to a built-in plug or mounting component.

FIGS. 9A-B illustrate a strap mounting assembly 270 that can comprise a mounting component 272 and a fastening component 274. Similar to the embodiment shown and discussed above in FIG. 6A (which description is incorporated herein by reference and will not be repeated for sake of brevity), the fastening component 274 can comprise a pad or bracket that can be attached to an end of a strap portion 276. Further, the fastening component 274 can comprise a mechanical fastener 280 that can be passed through the fastening component 274 and engage with an aperture 282 of the mounting component 272.

As noted herein, in some embodiments, the fastening component 274 can comprise an aperture or slot 284 into which the end of the strap portion 276 can be fitted. Optionally, an adhesive, such as those discussed herein, can be applied to enhance the engagement between the slot 284 of the fastening component 274 and the end of the strap portion 276. Thereafter, the mechanical fastener 280 can be disposed through both of the fastening component 274 and the strap portion 276. For example, in some embodiments, the mechanical fastener 280 can comprise a screw that can self-tap into and be screwed through the end of the strap portion 276 until engaging with the aperture 282 of the mounting component 272. The mechanical fastener 280 can preferably have a wide thread flank in order to enhance engagement between the fastener 280 and the mounting component 272.

FIG. 9C illustrates a cross-sectional view of an embodiment of a strap mounting assembly 300 that can be used in embodiments of the surfboard 200 discussed above. As illustrated, the mounting assembly 300 can comprise a mounting component 302 and a fastening component 304. The mounting component 302 (as with the other mounting components disclosed herein) can comprise an undercut portion 310 that can facilitate anchoring of the mounting component 302 into the material 320 of the surfboard. For example, the illustrated embodiment can represent a foam core surfboard in which the mounting component is anchored.

In accordance with an embodiment disclosed herein, a method of fabricating a strap-enabled surfboard is provided. An initial step of the method can comprise mounting or embedding one or more mounting components into a section of a surfboard. Next, once the one or more mounting components are properly positioned, the surfboard can be glassed on a top surface 322 thereof. Thereafter, mounting apertures (such as mounting aperture 330 shown in FIGS. 9A-C) can be formed in the top surface 322 of the surfboard.

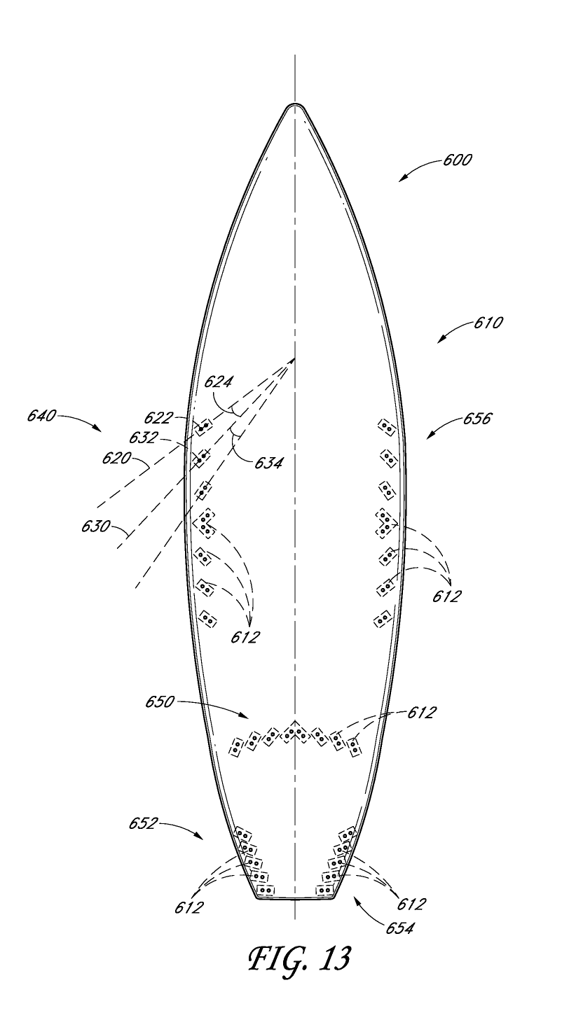

Further, a strap can be coupled to the mounting component 302 by inserting a fastening component 304 through the strap and into an engagement aperture 340 of the mounting component 302. In some embodiments, such as the embodiment illustrated in FIGS. 9A-C, a fastening component 304 can extend through the strap 342 (such as extending through and/or forming a hole formed in an end of a strap 342). However, as illustrated in FIGS. 13A-B, the fastening component can be an engagement portion of a bracket that is coupled to an end of the strap. Further, the fastening component can be a mechanical fastener, such as a screw, which can preferably have a wide thread flank in order to enhance engagement between the fastener and the mounting component 302.

The fastening component 304 can be configured as a removably mountable mechanism that can be securely fastened to the engagement aperture 340 of the mounting component 302. However, upon exertion of some force, the fastening component 304 can be removed by the user from the engagement aperture 340 of the mounting component 302. For example, the amount of force required could be between about 50 pounds and/or less than or equal to 150 pounds of force. Indeed, in order to ensure effective engagement during use, the force required to remove the fastening component 304 can be in excess of 70 pounds or more.

Additionally, the fastening component 304 can be configured to provide a quick release mechanism, such as a depressible button or other structure known in the art by which engagement between the fastening component 304 and the mounting component 302 can be disengaged to allow the fastening component 304 to be easily removed from the mounting component 302.

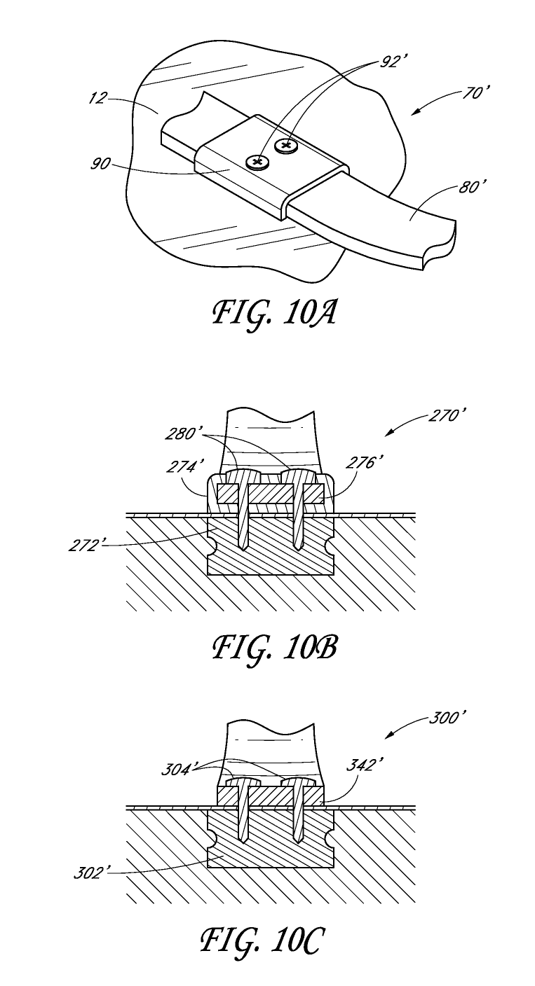

In accordance with other aspects, FIGS. 10A-C illustrate strap mounting assemblies 70′, 270′, 300′, which are modified versions of the embodiments shown in FIGS. 9A-C. Accordingly, the discussion of the embodiments of FIGS. 9A-C can be applied to the embodiment shown in FIGS. 10A-C (which discussion will not be repeated herein for brevity, but is incorporated by reference). In addition, some embodiments can be configured such that the strap mounting assembly comprises a plurality of fastening components configured to fix a rotational orientation of the strap relative to the surfboard and/or a mounting component installed within the surfboard. Thus, two, three or more fastening components can be used to fasten each end of a strap in a strap assembly such that the end of the strap does not rotate during the activity. In this manner, the strap can consistently respond during the course of the activity, for example, by being deflected towards the board and a popping up from the board in a consistent, repeatable fashion.

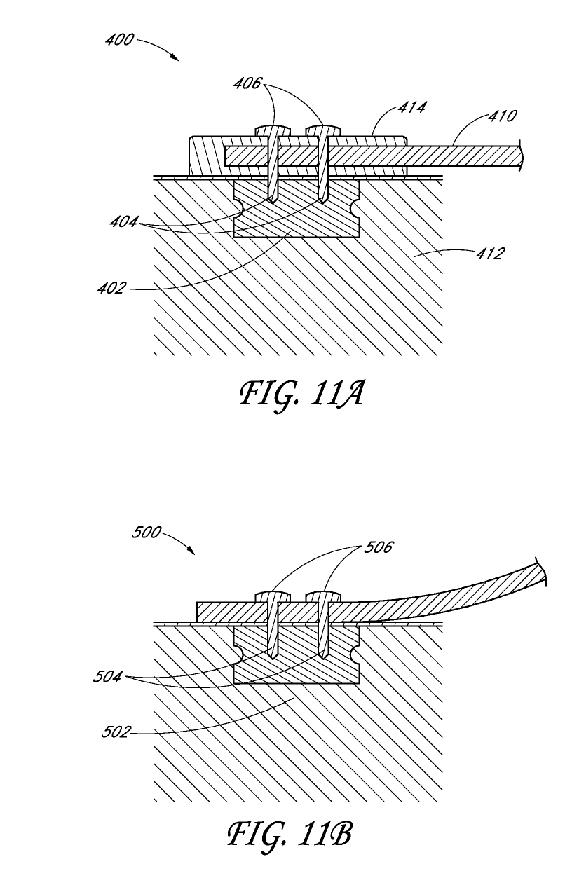

For example, the embodiments of FIGS. 10A-C illustrate that the mechanism can comprise a pair of fastening components 92′, 280′, 304′. Further, the pair of fastening components can be oriented crosswise relative to the longitudinal direction of the strap 80′, 276′, 342′. However, in some embodiments, the pair of fastening components can be aligned with the longitudinal direction of the strap 80′, 276′, 342′ (as shown generally in FIGS. 11A-B and as discussed below). Additionally, as illustrated in FIGS. 10B-C, the fastening components 92′, 280′, 304′ can engage with a mounting component 272′, 302′. Further, FIGS. 10A-B also illustrate that the strap mounting assemblies 70′, 270′ can comprise attachment components 90′, 274′, which can be configured in the manner described herein.

In accordance with some embodiments, the mounting component of the adjustable system can also be configured to comprise a pluarlity of apertures for receiving a corresponding pair of mechanical fasteners. For example, as discussed with respect to FIGS. 10A-C and as illustrated in FIGS. 11A-B, the strap mounting assemblies of FIGS. 9A-B can be modified to comprise dual fasteners. Thus, as shown in FIG. 11A, the strap mounting assembly 400 can comprise a mounting component 402 having a pair of apertures 404. As discussed above with respect to FIG. 9A (which discussion will not be repeated herein for brevity, but is incorporated by reference), fasteners 406 of the strap mounting assembly 400 can engage with the apertures 404 of the mounting component 402 to fasten a strap portion 410 relative to the surfboard 412. Further, similar to the embodiment shown in FIG. 9A, the mounting assembly 400 can also comprise a pad or bracket 414 that can be coupled with the strap portion 410 and mounted to the mounting component 402.

Similarly, as illustrated in FIG. 11B, the strap mounting assembly 500 can comprise a mounting component 502 having a pair of apertures 504. As discussed above with respect to FIG. 9A (which discussion will not be repeated herein for brevity, but is incorporated by reference), fasteners 506 of the strap mounting assembly 500 can engage with the apertures 504 of the mounting component 502. Other features and components of the strap mounting assembly 500 can be modified and/or implemented as discussed above and will not be repeated here and for sake of brevity.

FIGS. 11A-B also illustrate that in some embodiments, the mounting component can comprise a generally rectangular-shaped body having a recess, threads, or undercut disposed along an exterior surface thereof. However, the mounting component can also comprise a generally conical body having a plurality of threads disposed on the next eerier surface thereof, such that the mounting component can be screwed into the core of the surfboard. As noted above with respect to the mechanical fasteners, the recess, threads, or undercut of the mounting component can define a sufficiently wide flank so as to provide excellent engagement with the core of the surfboard, which in many cases can be made of foam. Indeed, for any of the mounting or engagement components taught herein, such as the embodiments illustrated in FIGS. 8-17, the body of the engagement or mounting component can be formed to comprise one or more corners and/or protruding features that could engage with the core of the surfboard to prevent rotation of the engagement or mounting component when rotational or torsional forces are exerted on the strap and indirectly exerted on the engagement or mounting component. Accordingly, although the engagement or mounting component can have a generally cylindrical body, some embodiments can advantageously incorporate anti-rotation features that can tend to stabilize the rotational orientation of the engagement or mounting component within the core of the surfboard.

In addition, FIGS. 11A-B also illustrate that the mounting assembly in some embodiments can be configured such that a strap is attachable to the mounting component using two or more attachment points or fastening mechanisms. In this regard, such embodiments of the mounting assembly can constrain or fix the rotational alignment of an end of the strap. Thus, in contrast to other embodiments disclosed herein which provide a single point of attachment (which can serve as a pivot point for the strap), the alignment of these straps can be set to a predetermined orientation in order to ensure that the strap is in the optimal alignment as the surfer pops-up and quickly slips their feet into the straps. Advantageously then, the straps can be set into a desired alignment and the desired alignment can be maintained.

In some embodiments, the mounting assembly for a single strap can comprise a pair of mounting components that each include two apertures used to attach the end of the strap to the mounting component. Thus, between both of the mounting components, four apertures are visible from a top view of the mounting system. In accordance with some embodiments, the four apertures can be placed in a row. For example, the apertures can be linearly aligned with each other such that a generally straight line can be drawn through each of the apertures. Such an alignment can be prepared by rotating the mounting components during the installation process (prior to glassing).

However, in accordance with some embodiments, the four apertures can also be misaligned such that the four apertures are not in a row and/or do not lie along a common line. In this manner, ends of the strap can be angularly oriented such that the side edges of the strap are vertically offset. Thus, the strap can define a “high side” and a “low side.” The “high side” of the strap can be defined as the side having an edge that extends higher than the edge of the other side. As a result, the “high side” can define a generally larger passing profile or opening than the “low side” of the strap. The openings in the strap can taper from the “high side” toward the “low side” and be oriented such that the surfer can insert their foot into the strap on the “high side” of the strap. In such embodiments, the strap can therefore generally provide a default shape that tapers in a manner similar to the taper of the foot, with the “low side” of the strap being on the “toe side” of the strap and the “high side” of the strap being on the “ankle side” of the strap. Thus, in some embodiments, the strap can be configured such that the edges of the strap help the strap take the general shape of an upper surface of a foot toward improving the comfort and fit of the strap.

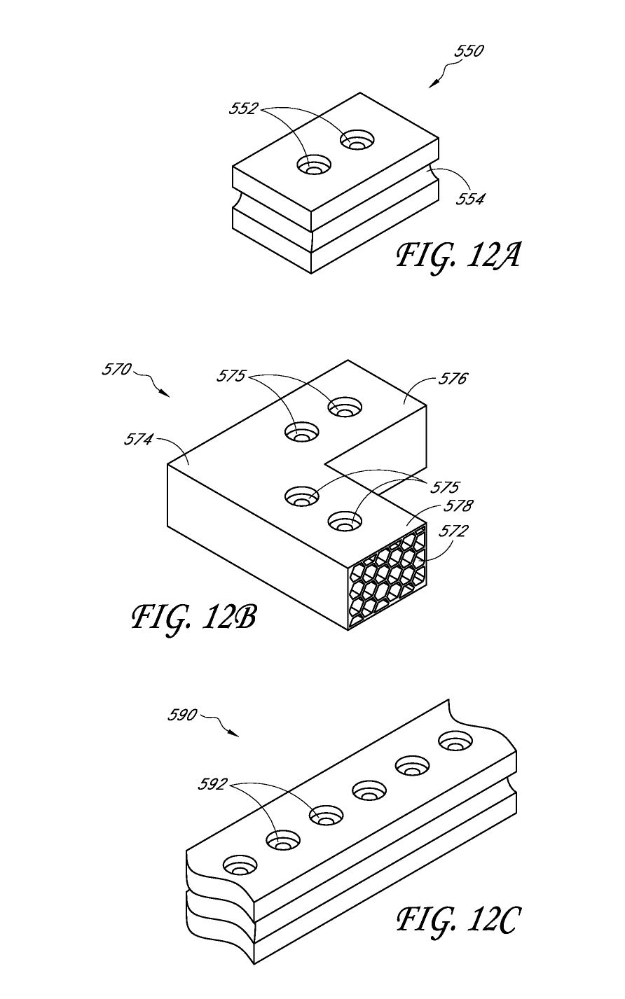

Referring now to FIGS. 12A-C, embodiments of mounting components are illustrated. The mounting component can comprise one or more apertures. As illustrated in FIG. 12A, a mounting component 550 can comprise a pair of apertures 552 that are outlined in a longitudinal direction of the body of the mounting component 550. As shown in other embodiments discussed above, the mounting component 550 can comprise and undercut portion 554 that can enhance engagement with the core of the surfboard and/or with an epoxy used to adhere to the mounting component 552 the surfboard core. However, the portion 550 can also comprise one or more protrusions, a surface texture, and other such features to increase the surface area and engagement with the surfboard core and/or an epoxy.

For example, in FIG. 12B, a mounting component 570 is provided that illustrates a honeycomb texture 572 on a side of the mounting component 570. The honeycomb texture can extend along one or more sides or the entire surface of the mounting component. The honeycomb texture is provided as an example of possible surface textures and can be used with any variety of mounting components taught herein. In addition, the mounting component 570 comprises a body 574 having an L-shape. The shape of the body 574 can also be configured as a zig-zag, an S-shape, and/or other shapes and/or combinations of such shapes in order to provide a desired body orientation and/or surface area. In this regard, the body 574 can be configured to house a plurality of apertures 575. In the illustrated embodiment, separate sections or legs 576, 578 of the body 574 comprise apertures 575 aligned in different rotational orientations. The sections or legs 576, 578 can be oriented at generally perpendicular orientation. However, in some embodiments, the sections or legs 576, 578 can be angularly oriented at an obtuse angle. The angle can be between at least about 95 degrees and/or less than or equal to about 170 degrees.

Thus, in some embodiments, the body of a mounting component can advantageously be shaped to enable a variety of different aperture alignments, which can enable a manufacturer or user to select a desire orientation for installing into the board. Further, the variety of different aperture alignments can enable a user to optimize the strap orientation for use during the activity.

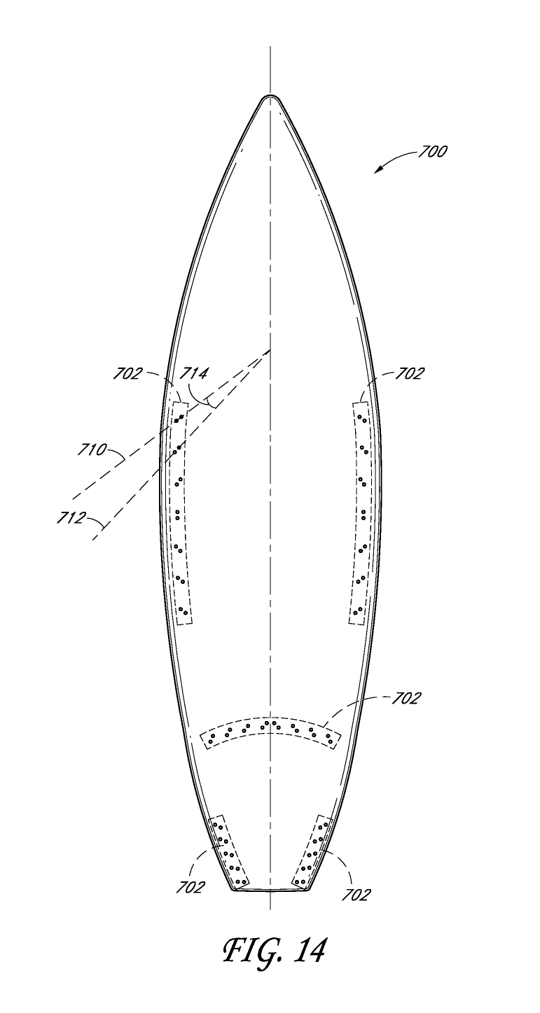

FIG. 12C illustrates another embodiment of a mounting component 590 in which the mounting component 590 comprises a series of apertures 592. As shown, the embodiment of FIG. 12C illustrates that the mounting component can be comprised as a generally elongate body. In some embodiments, the body of the mounting component can be linear. However, in other embodiments, the body of the mounting component can be arcuate, which can enable the mounting component to conform to a side of the surfboard, as illustrated generally in FIG. 14. The apertures 592 can extend along the length of the mounting component 590. The apertures 592 can be spaced equidistant from each other in order to allow a finer degree of adjustment and positioning of the attachment component of the assembly.

FIG. 13 illustrates a top view of a strap-enabled surfboard 600, similar to the embodiment illustrated in FIG. 8. As shown, the surfboard 600 can comprise a mounting system 610 having an array or a plurality of plugs or mounting components 612. The mounting components 612 are illustrated as having two or more apertures, such as the mounting components illustrated in FIGS. 12A-C. In some embodiments, the longitudinal axes of one or more mounting components can be oriented parallel relative to each other and/or the longitudinal axes of one or more mounting components can be oriented at an angle relative to each other. Thus, the mounting components 612 can also be oriented at a desired angular orientation relative to each other such that the aperture of the mounting components 612 are aligned in a desired manner.

For example, a longitudinal axis 620 of a first mounting component 622 can be oriented at an angle 624 relative to a longitudinal axis 630 of a second or successive mounting component 632. In some embodiments, the angle formed between longitudinal axes of adjacent mounting components can be between at least about 5 degrees and/or less than equal to about 45 degrees. Further, the angle formed between longitudinal axes of adjacent mounting components can be between at least about 10 degrees and/or less than equal to about 25 degrees. Further, in a series of seven or eight mounting components, an angle 624 can be approximately equal to an angle 634 formed between the longitudinal axes of successive mounting components. Thus, the series of mounting components can be configured such that the orientation of apertures of successive mounting components varies along the length of the series.

For example, in the illustrated embodiment, in a series 640 of mounting components 612 on the left side of the surfboard 600, the apertures of a topmost mounting component define a longitudinal axis that is nearly horizontal and with each successive component approaching the middle of the series, the longitudinal axis of the respective apertures becomes increasingly vertical until reaching an inflection point at the middle of the series whereafter the longitudinal axes progressed from generally vertical to increasingly horizontal. The progression of the angular orientation of mounting components in other series 650, 652, 654, 656 of mounting components 612 can implement aspects of the series 640 discussed above.

FIG. 14 illustrates another embodiment of a strap-enabled surfboard 700 having a plurality of mounting components 702 built into a core thereof. Similar to the embodiment of the surfboard 600 discussed above, the mounting component 702 of the surfboard 700 can also comprise a plurality of pairs of apertures. The pairs of apertures can each define a longitudinal axis, and as discussed above with respect to FIG. 14, the longitudinal axes of the apertures can be configured to intersect in a desired manner.

For example, the longitudinal axes 710, 712 illustrated in FIG. 14 can be configured to intersect and form an angle 714. The longitudinal axes of each successive pair of apertures can define an angle therebetween, as discussed above with respect FIG. 13 (the discussion of which will not be repeated for brevity and is hereby incorporated herein by reference). Therefore, each of the mounting components 702 can be uniquely fabricated as elongate components (instead of a series of individual mounting components) having a plurality of pairs of apertures for engaging with strap mounting assemblies. The mounting components 702 can advantageously enable a manufacturer to prepare fewer mounting components for insertion for installation into the core of the surfboard. Further, the orientation and precision of angular offsets can be accurately performed using larger mounting components. Furthermore, the mounting components 702 can provide greater pull out strength than smaller, individual mounting components due to the increased surface area and engagement between a mounting components 702 and the core of the surfboard.

Accordingly, embodiments of the strap-enabled surfboard can be provided in which the longitudinal axes of apertures can be angularly offset with respect to each other in a desired fashion. However, as illustrated above in FIG. 12C, a line of apertures can be provided in individual mounting components (such as in FIG. 13) and/or in combined mounting components (such as in FIG. 14). In this regard, the angular orientation or offset of the fastening components that engage linearly-aligned apertures (such as in FIG. 12C) can be modified such that the strap is coupled relative to the linearly-aligned apertures at a desired (and fixed) angle. Various modifications, combinations, and implementations of the teachings herein can provide for other mounting component, fastening component, and attachment component configurations.

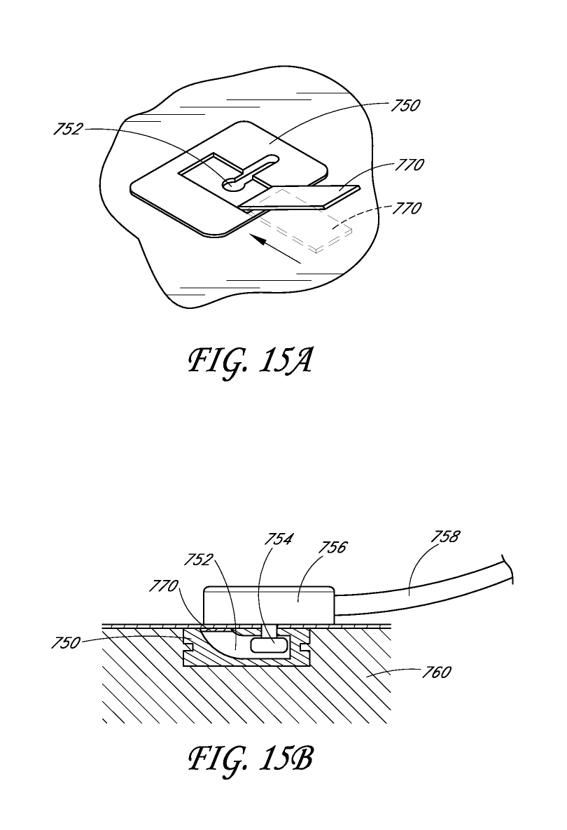

FIGS. 15A-B illustrate another embodiment of a mounting component 750. In the illustrated embodiment, the mounting component 750 can comprise an engagement section 752, such as a slot, groove, protrusion, or recess configured to engage with an engagement component 754 of a bracket 756 attached to an end of a strap portion 758. The engagement component 754 of the bracket 756 can comprise a protrusion, slot, groove, or recess corresponding to the engagement section 752. This embodiment can operate similarly to the embodiment shown and discussed above with reference to FIG. 7. However, as shown in the side view of FIG. 15B, the mounting component 750 can be embedded into the surfboard core 760.

Further, the mounting component 750 can optionally include a locking mechanism 770 that can operate by sliding or rotating relative to the engagement section 752 of the mounting component 750. Furthermore, the locking mechanism 770 can comprise one or more slidable or rotatable components that can be positioned against a portion of the engagement section 752. For example, the locking mechanism 770 can be rotated (as shown in solid lines) until snapping into place to cover the open end of the slot embodiment of the engagement section 752. Additionally, as shown in dashed lines, the locking mechanism 770 can slide into place to cover at least a portion of the engagement section 752. Accordingly, a locking mechanism 770 can be used to limit movement and/or prevent the engagement component 754 from exiting the slot or engagement section 752.

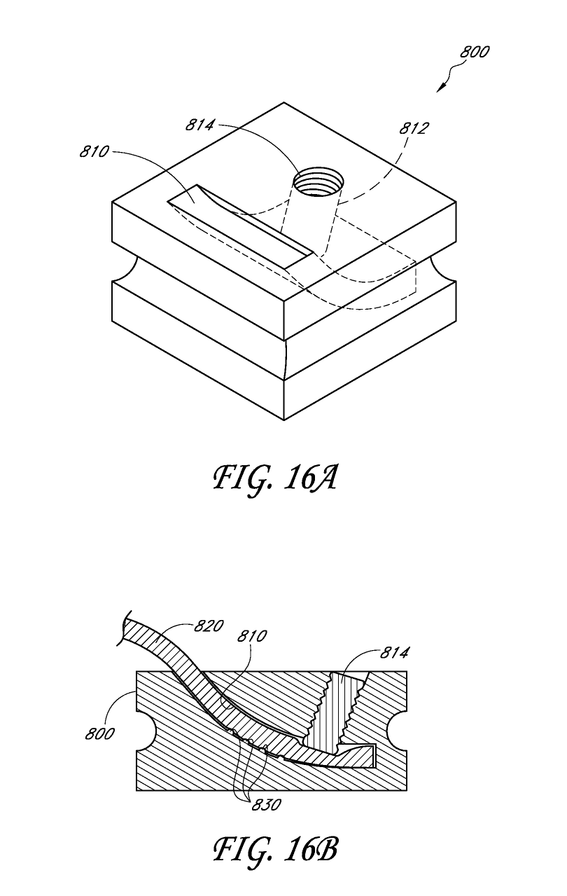

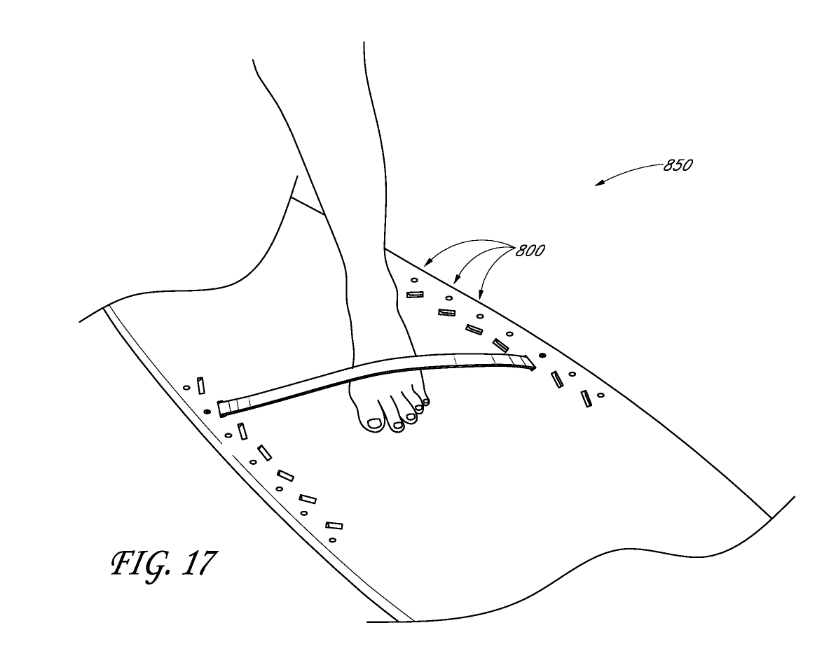

FIGS. 16A-17 illustrate another embodiment of a mounting component, fastening component, and attachment component. FIG. 16A illustrates an engagement component 800 that can be installed into a core of the surfboard, similar to the mounting components discussed herein. The engagement component 800 can comprise an elongate slot 810, a fixation aperture 812, and a fastening component 814.

In this embodiment, as shown in FIG. 16B, the elongate slot 810 can be configured to receive an end portion of a strap 820. When the strap 820 is fitted to an end or bottom of the slot 810, the fastening component 814 can be actuated to compress and/or pierce a portion of the strap 820, thereby engaging the strap 820 relative to the engagement component 800. In some embodiments, the slot can comprise one or more ridges, teeth, or textural components 830 for enhancing the engagement of the strap 820 within the slot 810. FIG. 17 illustrates an embodiment of a strap-enabled surfboard 850 having a system of engagement components 800 installed therein. As illustrated, the system of engagement components 800 can provide a generally smooth upper surface to the surfboard while providing a variety of strap positions at which the strap can be mounted. Similar to the embodiments of FIGS. 13-14, the slots 810 of the engagement components 800 can be arranged in a desired orientation relative to each other (so as to be parallel and/or obliquely oriented relative to each other). Further, although only a medial section of the surfboard 850 is illustrated, the mounting components 800 can also be installed at a rear or tail portion of the surfboard 850. Further, although FIG. 16A illustrates a single engagement component 800, the engagement component can be combined with other engagement components to form a combined engagement component as an elongate unit, similar to the embodiment illustrated in FIG. 14.

The mounting component in any of the embodiments disclosed herein can be sized to define a circumference or width of between at least about ½ inch and/or less than or equal to about 2 inches. Further, the mounting component can be sized to define a circumference or width of between at least about ¾ inch and/or less than or equal to about 1½ inches. In some embodiments, such as those illustrated in FIGS. 11A-B, the mounting component can be sized to define a circumference or width of about ⅞ inch. Further, the height or depth of the mounting component can be between at least about ¼ inch and/or less than or equal to about 1 inch. In some embodiments, the height or depth of the mounting component can be between at least about ⅓ inch and/or less than or equal to about ¾ inch. Further, some embodiments can be configured such that the height or depth of the mounting component is about ½ inch. Accordingly, the size and external geometry of the mounting component can be configured such that the surface area in contact with the core of the surfboard is maximized in order to ensure that the mounting component is not torn away from the core of the surfboard during use.

As discussed herein, various configurations and structures have been provided for mounting one or more straps to a surfboard, whether using a permanent, semi-permanent, or adjustable system. Although the illustrated embodiments provide examples of such configurations, it will be understood that certain features can be interchanged, replaced, or omitted in some embodiments.

Therefore, although embodiments of these inventions have been disclosed in the context of certain examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions.

What is claimed is:

1. A surfboard for maintaining a surfer's feet adjacent to a top surface of the surfboard during a surfing maneuver, the surfboard comprising:
a core defining a nose, a tail, opposing side edges, and an upper surface of the surfboard; and
a plurality of mounting components disposed in the core of the surfboard, the plurality of mounting components being arranged to form a mounting array that extends at least partially along two or more areas of the upper surface of the surfboard, the mounting components being configured to interconnect with respective ends of at least one strap such that the strap can extend at least partially across the upper surface of the surfboard.

2. The surfboard of claim 1, wherein the plurality of mounting components comprises at least a pair of forward mounting components and a pair of rear mounting components.

3. The surfboard of claim 2, wherein the pair of forward mounting components are positioned adjacent to the opposing side edges of the surfboard, and wherein at least one of the mounting components of the pair of rear mounting components is positioned adjacent to a side edge of the surfboard.

4. The surfboard of claim 1, wherein the plurality of mounting components comprises a set of forward mounting components and a set of rear mounting components, the forward mounting components being positioned adjacent to opposing side edges of the surfboard, at least one of the mounting components of the set of rear mounting components being positioned adjacent to a side edge of the surfboard.

5. The surfboard of claim 4, wherein the forward mounting components are arranged in rows extending adjacent to the opposing side edges of the surfboard.

6. The surfboard of claim 4, wherein the rear mounting components are arranged in rows extending adjacent to the opposing side edges of the surfboard.

7. The surfboard of claim 6, wherein the rear mounting components further comprise a row extending transversely relative to a longitudinal axis of the surfboard and being positioned generally intermediate the forward mounting components and the rows of rear mounting components.

8. The surfboard of claim 1, further comprising at least a first elongate strap defining first and second ends, the first and second ends of the first elongate strap being attachable to respective mounting components of the surfboard.

9. The surfboard of claim 8, further comprising a second elongate strap defining first and second ends, the first and second ends of the second elongate strap being attachable to respective mounting components of the surfboard such that the second elongate strap is positioned generally between the first elongate strap and the tale of the surfboard.

10. A surfboard foot strap assembly for use with a surfboard for maintaining a surfer's feet adjacent to a top surface of the surfboard during a surfing maneuver, the assembly comprising:
a pair of first mounting pads having an engagement complement and a lower surface being attachable to the top surface of the surfboard; and
a first elongate strap having opposing ends being coupled to the respective ones of the pair of first mounting pads, the first elongate strap being attachable to the top surface of the surfboard to define a first opening having a first width, the first elongate strap being configured to extend transversely relative to a longitudinal axis of the surfboard, the first elongate strap further being configured to be attachable to the top surface of the surfboard adjacent to opposing side edges of the surfboard such that the first width of the first opening is at least about 12 inches.

11. The assembly of claim 10, further comprising a pair of second mounting pads and a second elongate strap having opposing ends being coupled to the respective ones of the pair of second mounting pads, the second elongate strap being attachable to the top surface of the surfboard to define a second opening having a second width, the second width being at least about 12 inches.

12. The assembly of claim 10, wherein the first width is between at least about 12 inches and/or less than or equal to about 26 inches.

13. The assembly of claim 11, wherein the second width is between at least about 12 inches and/or less than or equal to about 22 inches.

14. The assembly of claim 11, wherein the first and second straps are biased toward a deployed position in which central portions of the first and second straps are spaced from the top surface of the surfboard, and wherein the first and second straps are deformable toward a stowed position in which the central portions of the first and second straps are positioned adjacent to the top surface of the surfboard.

15. A method of providing a surfboard foot strap system comprising:
installing a plurality of mounting components into a core of a surfboard, the plurality of mounting components comprising one or more mounting components positioned adjacent to opposing side edges of the core along a top surface of the surfboard.

16. The method of claim 15, further comprising arranging the plurality of mounting components in two or more rows.

17. The method of claim 15, wherein the arranging step comprises arranging at least one row of the mounting components to extend along the length of the surfboard.

18. The method of claim 15, wherein the arranging step comprises arranging at least one row of the mounting components to extend adjacent to a side edge of the surfboard.

19. The method of claim 15, wherein the arranging step comprises arranging at least one row of the mounting components to extend transversely relative to a longitudinal axis of the surfboard.

20. The method of claim 15, wherein the arranging step comprises arranging a pair of forward rows of mounting components along a medial portion of the surfboard adjacent to opposing side edges thereof, arranging a pair of rear rows of mounting components along a tail portion of the surfboard adjacent to opposing side edges thereof, and arranging a transverse row of mounting components to extend transversely relative to a longitudinal axis of the surfboard and generally between the forward rows and the rear rows.
